(19) United States
(12) Patent Application Publication
(10) Pub. No.: US 2014/0006451 A1
(43) Pub. Date: Jan. 2, 2014

(54) Remote-Controllable Kiosk

(71) Applicants: Karen Mullis, Loganville, GA (US); Mark Edward Causey, Tucker, GA (US); Brian Kevin Daly, Seattle, WA (US); Qingmin Hu, Sammamish, WA (US); Jamie Toren, Atlanta, GA (US)

(72) Inventors: Karen Mullis, Loganville, GA (US); Mark Edward Causey, Tucker, GA (US); Brian Kevin Daly, Seattle, WA (US); Qingmin Hu, Sammamish, WA (US); Jamie Toren, Atlanta, GA (US)

(73) Assignees: AT&T MOBILITY II LLC, Atlanta, GA (US); AT&T INTELLECTUAL PROPERTY I, L.P., Atlanta, GA (US)

(21) Appl. No.: 13/539,334

(22) Filed: Jun. 30, 2012

(51) Int. Cl. G06F 17/30

(52) U.S. Cl. 707/784; 707/E17.059

(57) ABSTRACT

Devices, systems, and methods are disclosed which relate to enabling wireless communication between an information kiosk and a mobile device operated by a user. The user may operate the mobile device to request information from the kiosk, with the kiosk authenticating the user before displaying information. The authentication may involve a biometric identifier. The kiosk may provide information to the user via the display on the kiosk or on the mobile device. The profile may be regularly updated with the user's past queries, and other biographical information. Consequently, the user may be able to receive information pertinent to their needs without having to come into physical contact with the kiosk. Kiosks may be installed at public transit terminals such as bus stops, shopping centers or malls, attractions such as amusement parks, museums, etc.

### BACKGROUND OF THE SUBJECT DISCLOSURE

1. Field of the Subject Disclosure

The subject disclosure relates to public information kiosks. More specifically, the subject disclosure relates to public information kiosks enabled to provide information customized to a user viewing the kiosk.

2. Background of the Subject Disclosure

Public information displays are widespread and useful in many instances such as at street corners, in bus stations, at mall directories, etc. Some displays may be interactive, such as kiosks having user interfaces accessible via a user seeking a particular type of information. However, these existing kiosks are limited in the services they can offer. For instance, a kiosk provides virtually the same type and content of information via the same interface for all users, regardless of the specific requirements of the user. Moreover, existing kiosks often require users to share the same input devices, like touchscreens, etc., as previous users. This communal usage has obvious health and sanitary issues for the public. Furthermore, leaving a public record of the user's information query stored within the kiosk and accessible by the next user may compromise the privacy of a user, which is a growing cause for concern.

### SUMMARY OF THE SUBJECT DISCLOSURE

The subject disclosure presents devices, systems, and methods for wirelessly coupling a kiosk to a user's mobile device to enable remote control and personalization of the kiosk. In one exemplary embodiment, the subject disclosure is a system including a kiosk having a processor, a display, and a transceiver, and a computer-readable medium in communication with the processor, the computer-readable medium including computer-readable instructions that are executed by the processor to perform operations including receiving a connection request from a mobile device associated with a user, presenting a plurality of options, receiving a query from the mobile device, the query identifying at least one of the plurality of options, presenting a response based on the query, and storing the query, the response, and any subsequent query in a profile for the user. The profile may be stored in a database in communication with the kiosk. The query may be submitted responsive to a user input detected via a user interface on the mobile device. The profile may be stored on a database in communication with the kiosk.

In another example embodiment, the subject disclosure is a method performed by a kiosk having at least one processor for receiving a query from a mobile device in communication with the kiosk, the query including an identifier of a user of the mobile device, presenting, a response to the query, and storing, on a database in communication with the kiosk, the query, the response, and any subsequent query in a profile associated with the user. wherein the query is submitted responsive to a user input detected at an interface on the mobile device. The method may further include checking the database for an existing profile associated with the user.

In yet another example embodiment, the subject disclosure is a computer program product embodied on a computer-readable medium, the computer program product including instructions that are executed by a processor including at least one processor for receiving a connection request from a mobile device in communication with a kiosk, the connection request including a query and an identifier of a user of the mobile device, presenting a response to the query via a display, and storing the query and the response in a profile associated with the user, the profile being stored on a database in communication with the kiosk.

### BRIEF DESCRIPTION OF THE DRAWINGS

FIG. 1 shows a system for remotely controlling a kiosk, according to an example embodiment of the subject disclosure.

FIG. 2 shows a method for providing information to a user, according to an example embodiment of the subject disclosure.

FIGS. 3A and 3B show a mobile device for remotely controlling a kiosk, according to an example embodiment of the subject disclosure.

FIG. 4 shows a method for remotely controlling a kiosk, according to an example embodiment of the subject disclosure.

FIG. 5 shows a kiosk being remotely controlled by a mobile device, according to an example embodiment of the subject disclosure.

FIG. 6 shows a kiosk being remotely controlled by two mobile devices, according to an example embodiment of the subject disclosure.

FIG. 7 shows a kiosk being remotely controlled by two mobile devices with one mobile device in a private session, according to an example embodiment of the subject disclosure.

FIG. 8 shows a system including a plurality of locally-distributed kiosks, according to an example embodiment of the subject disclosure.

FIG. 9 shows a system including a plurality of widely-distributed kiosks, according to an example embodiment of the subject disclosure.

### DETAILED DESCRIPTION OF THE SUBJECT DISCLOSURE

The subject disclosure presents systems and methods for enabling wireless communication between an information kiosk and a mobile device operated by a user. The kiosk may include a display, a processor, a memory, and a transceiver. The user may request information from the kiosk by selecting from a menu of options or by otherwise submitting a query. The kiosk may authenticate the user before displaying information. The authentication may involve a biometric identifier on the mobile device that transmits a unique identifier associated with the user to the kiosk. The kiosk may provide information to the user via the display on the kiosk or on the mobile device. The information provided may be customized for the user. The customization may be enabled by a profile for the user stored on a database in communication with the kiosk. The profile may be regularly updated with the user's past queries, and other biographical information. Consequently, the user may be able to receive information pertinent to their needs without having to come into physical contact with the kiosk.

The systems, devices, and methods generally described in the following example embodiments include requesting information from kiosks installed at public transit terminals such as bus stops, kiosks installed within shopping centers or malls, thereby acting as a store directory, and kiosks installed within attractions such as amusement parks, museums, etc. However, many other situations are conceivable and may become apparent to those having ordinary skill in the art upon reading this disclosure, such as office buildings, exhibits, casinos, automated teller machines (ATM), retail point of sales such as checkout counters at grocery stores, etc.

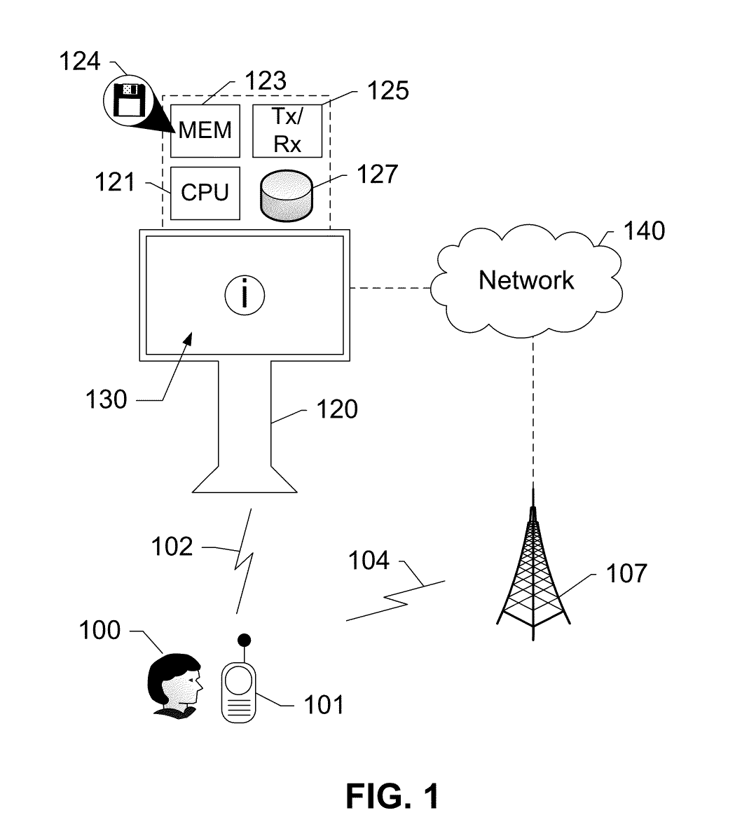

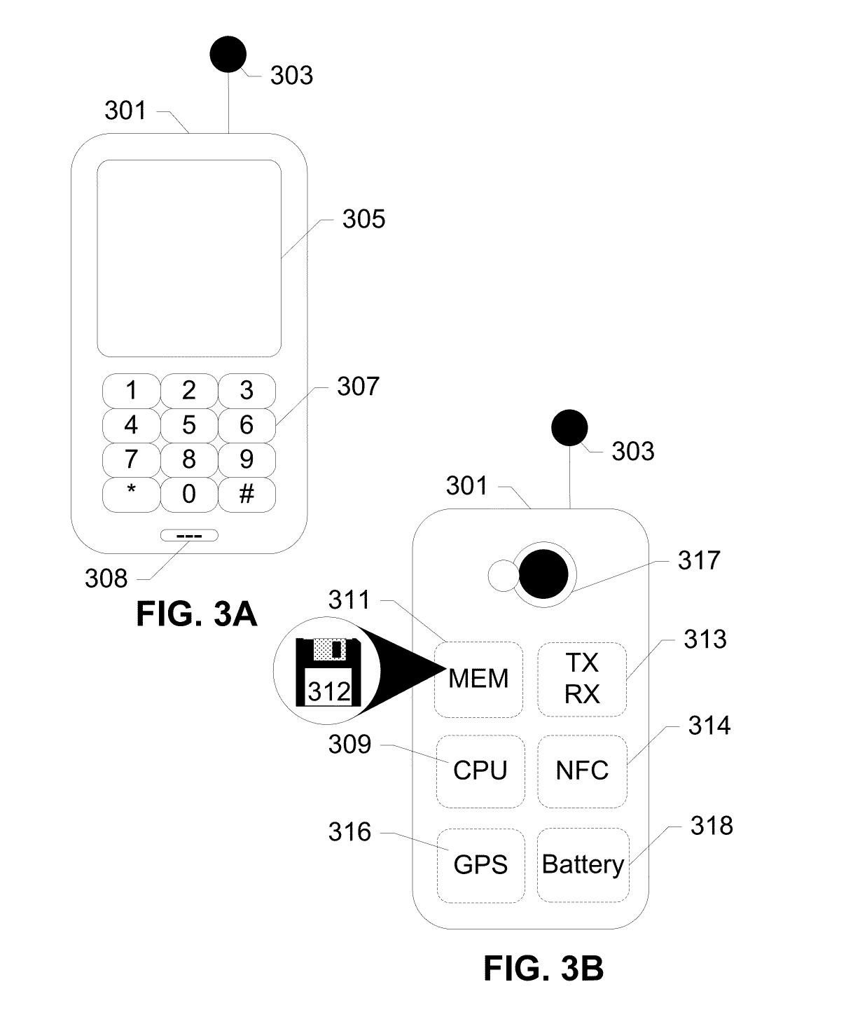

FIG. 1 shows a system for remotely controlling a kiosk, according to an example embodiment of the subject disclosure. The system includes a user 100 operating a mobile device 101. Mobile device 101 may be in wireless communication with a kiosk 120 over a wireless connection 102, and may further be in communication with a radio network 107 over a wireless connection 104. Either of wireless connections 102 and 104 may be implemented via any mechanism including near-field communication (NFC), WiFi, cellular, broadband, etc. Consequently, and as shown below with respect to FIG. 3, mobile device 101 may include one or more appropriate transceivers to enable such communication. For example, mobile device 101 may include a cellular transceiver for communicating with radio network 107, and a BLUETOOTH® transceiver for communicating with a BLUETOOTH® enabled kiosk 120. Kiosk 120 may also include a display 130. Display 130 may be an LCD, LED or any other type of display on which a user can view the information they are looking for. Further, kiosk 120 may also include one or more transceivers such as transceiver 125 for enabling such communication. Kiosk 120 may also include a processor 121 in communication with a computer-readable medium, such as a memory 123, as well as a transceiver 125, and database 127. Memory 123 may store a computer-readable logic 124 that includes computer-readable instructions that are executed by the processor to communicate with and disseminate information to a user 100 of mobile device 101. Software is one example of such logic 124. Logic may also be comprised by digital and/or analog hardware circuits, for example, hardware circuits comprising logical AND, OR, XOR, NAND, NOR, and other logical operations. Logic may be formed from combinations of software and hardware, including processor 121 to execute instructions comprised by logic 124. Transceiver 125, as well as radio network 107, may further enable access to a wide-area network such as network 140. Network 140 may include broadband wide-area networks such as cellular networks, the Internet, etc. A network typically includes a plurality of elements that host logic for performing tasks on the network, such as proxy servers, authentication servers, application servers, databases, etc. For instance, network 140 may enable access to a service provider's core network, including account information for user 100 and an owner/operator of kiosk 120, billing server, as well as a central storage database for user 100.

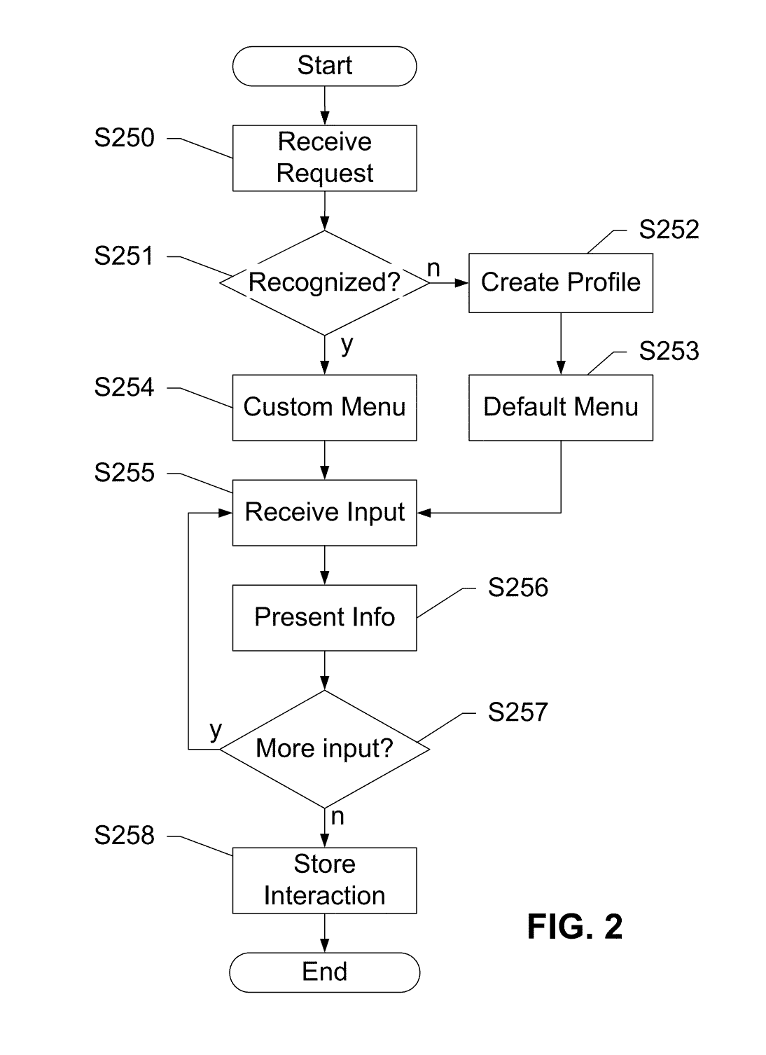

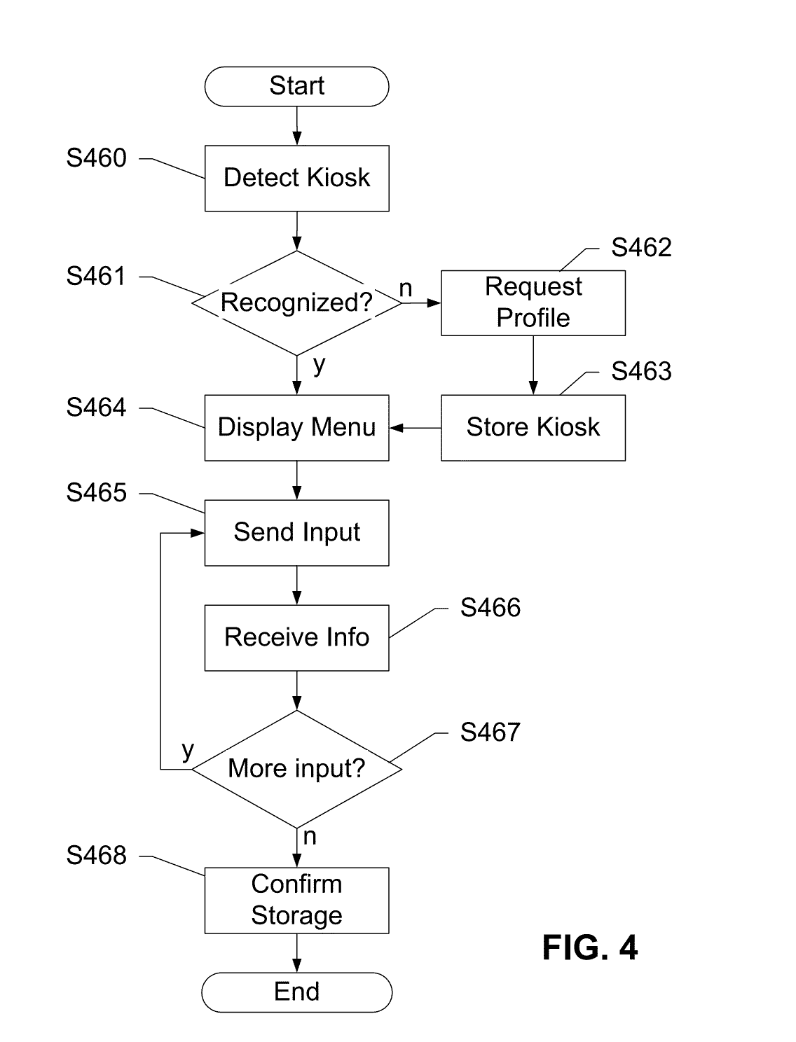

In operation, user 100 may approach to within a communication range of kiosk 120 sufficient to enable connection 102. Any combination of transceivers within mobile device 101 or kiosk 120 may detect this communication range, and trigger an alert to the user. The communication range of connection 102 may depend on the type of transceivers being used. For instance, an NFC transceiver may have a range of a few cm while a BLUETOOTH® transceiver may have a range of about 10 m. In either case, logic within mobile device 101 may alert user 100 of the presence of kiosk 120, and may provide the user with an option to connect with kiosk 120 to request information. If user 100 does not wish to connect to kiosk 100, he may ignore or deny the prompt and move along his way. If user 100 wishes to connect with kiosk 120 to retrieve information, he may initiate connection 102 by commanding mobile device 101, for instance by pushing a button, selecting an option, etc. Such an action may trigger any combination of methods for acquiring information, such as the methods described below with respect to FIGS. 2 and 4, etc. Briefly, upon receiving a connection request, kiosk 120 may present the user with a menu of options. Depending on the user's preferences, the menu of options may be displayed on display 130 of kiosk 120, on a display of mobile device 101, or any combination thereof. The choice of where to display the menu of options, as well as the options themselves, may be customized to the user's preferences. For instance, user 100 may have a profile including a list of preferences and/or a history of interactions. The profile may be stored in any database accessible to kiosk 120, such as within database 127, or stored on a central database within network 140. A user accessing kiosk 120 for the first time may be prompted to create a profile and/or presented with a default menu, while a user with an existing profile may be provided menu options customized for his or her needs. The customization may be based upon the user's search history, defined preferences, etc., and determined by logic 124 within kiosk 120.

User 100 may interact with kiosk 120 using mobile device 101 as a remote control. For instance, a user interface may be provided on mobile device 101 via a logic stored on a memory on mobile device 101. The user interface may include controls corresponding to commands that may be used to select options displayed or able to be understood by logic 124 on kiosk 120. Such an interaction may enable user 100 to control kiosk 120 without coming into physical contact with kiosk 120, and therefore avoiding any contamination on their hands, etc. Moreover, such interaction may enable multiple users such as user 100 to control and receive information from kiosk 120 concurrently, as in the additional example embodiments described herein. The interaction generally involves providing input in the form of a selection or query to kiosk 120 via mobile device 101, receiving information in response to the query, and repeating this process until user 100 is satisfied with the information received. Then the user may terminate the session via a command on mobile device 101. Upon or before termination, the interaction may be stored in the user's profile so as to enable more customization for future uses of kiosk 120. This interaction may include the user's selections, as well as other information such as the user's history of interactions, geographical location, preferences, biographical information, etc. The interaction may be stored whether it is a first-time or a known user, with the first time user's profile being created before the interaction is stored in said profile. The profile may be stored on database 127 within kiosk 120, on an online database on network 140, and any combination thereof. Moreover, mobile device 101 may store the interaction independently, either on a local storage or on network 140 via radio network 107, and may also store information related to the kiosk, so as to potentially recognize new kiosks owned or operated by the same entity.

For instance, kiosk 120 may be installed in a public transit terminal, such as a bus station. User 100 may approach to within a range of kiosk 120 and initiate an interaction as described herein. If the user has an existing profile stored within kiosk 120 or in a central profile accessible to kiosk 120, logic 124 may retrieve this information, and display options that are customized for the user. The user may regularly take a certain bus to work, and this information may be stored in the user's profile, enabling kiosk 120 to automatically display the next available bus, a route map, as well as alternate options for user 100 to get to work. These options may be displayed on display 130 of kiosk 120, on a display of mobile device 101, or any combination thereof. Any interaction between user 100 and kiosk 120 may be performed via controls or options displayed on mobile device 101, enabling user 100 to remotely control kiosk 120. This interaction may be given a time limit if other users are waiting to use kiosk 120, or display 130 of kiosk 120 may be split among multiple users as further described herein. In another situation, kiosk 120 may be installed in a shopping mall and serve as a mall directory. Here, user 100 may approach kiosk 120 with the intention of performing at least one of several different queries, such as looking up a retail outlet, searching for a particular item, finding a price or availability of an item, and even receiving recommendations for additional or alternative items. The recommendations, as well as pricing information, etc. may be based on the user's profile, search history, location, etc. For instance, the user's profile may be connected to the user's budget via a budgeting application/service offered by the service provider, and only items matching the budget will be shown to the user, with more expensive or additional items being indicated as such. Multiple kiosks distributed throughout the shopping mall may be coupled to a central server in a local area network connecting the kiosks, such that information is provided to the user based on the user's location within the mall. Similar concepts may be applied to the situation where a kiosk 120 is installed in a tourist or other attraction, such as a museum. User 100 may be visiting the museum and may have an itinerary planned, whereby the kiosk may direct the user to specific locations or exhibits based upon the user's itinerary programmed into the user's schedule. Many other combinations and uses are possible, such as coupling a user's profile to their personal or business schedule stored on the cloud, etc.

FIG. 2 shows a method for providing information to a user, according to an example embodiment of the subject disclosure. According to this method, a user may detect, via their mobile device, a presence of a kiosk, and transmit a request that is received S250 by the kiosk. Other methods for receiving the request S250 may be possible, such as the kiosk detecting the mobile device and “pushing” a notification to the mobile device, and subsequently receiving the request. For instance, a user may approach to within a communication range of the kiosk sufficient to enable such detection via any combination of transceivers within the mobile device or the kiosk. This detection may trigger an alert to the user via the mobile device. The alert may further be provided by the kiosk, such as a display or an audio signal indicating to the user to enable communication by commanding their mobile device. For instance, logic within the mobile device may alert the user of the presence of the kiosk, and may provide the user with an option to connect with the kiosk to request information. If the user does not wish to connect to the kiosk, he may ignore or deny the prompt and move along his way. In the case that the user enables the interaction, the request is received S250, and may include at least an identifier of the mobile device, and may further include a query for a particular information. The identifier may be any unique identifier that serves to identify the user of the mobile device. This identifier may be used to recognize S251 the user. Recognition S251 may include searching a local or network database for a profile of the user. If the profile does not exist, for instance if the user is accessing the kiosk for the first time, logic on the kiosk may create a profile S252 for the user. The profile may be created on a database within the kiosk, on a central server on a local area network in communication with the kiosk, on a central database on a service provider's network or on the cloud/internet accessible to the kiosk via a transceiver coupled to the kiosk, etc. In either case, the profile may be created S252, and a default menu of options may be presented to the user S253. If the user is recognized S251, a custom menu may be generated S254 and presented to the user. Either the default or custom menu of options may be presented on a screen of the kiosk, on the mobile device operated by the user, or any combination thereof.

The content of either menu of options may depend on many factors, including the user's profile (whether new or old), the user's location, any query submitted in S250, and so on. For instance, the default menu presented S253 may be generic to any new user, since the user's profile generated in S252 is empty. In the case of a public transit terminal, or a mall directory, the default menu may include a generic selection of information services. Alternatively, the user's location, time of day, and any relevant information available to the terminal may be used to provide a default menu that may be mildly customized based upon the context. The customized menu S254, however, may be generated using any information in the user's profile, such as past or most frequent searches, personal preferences defined by the user, etc. In either case, the menu options may further be presented in response to a query submitted in initial request S250. For instance, a query from a new user requesting information on men's shoes from a kiosk in a mall may result in a list of men's shoe stores within the mall and directions to said stores, while an identical query from a user already having a profile could limit the list of options to shoe stores having items matching the user's shoe size, budget, purchase history, age, and any other information available to the kiosk. Further, the choice of where to display the menu of options may be customized to the user's preferences.

The interaction continues with the kiosk receiving an input in the form of a query or menu selection S255 from the user via the user's mobile device. This may be a continuation of the previous interaction, such as narrowing down a bus route to a specific time, or a particular product to a range of prices. Alternatively, this may include a new query, such as selecting a train instead of a bus, or adding an item to be purchased to the query. In either case, a response may be presented S256 to the user (either on the kiosk or on the mobile device) and the interaction process may repeat itself or may end, depending on the outcome of decision S257. For instance, if the user continues to provide input, narrowing or broadening his query, steps S255-S257 may be repeated. If there is no more input from the user, or if the user somehow terminates the session, for instance via a command on his mobile device, the entire interaction may be stored S258 in the user's profile so as to enable more customization for future uses of this or another connected kiosk. The information stored S258 may include every query and selection from a menu of options, as well as other information such as the user's history of interactions, geographical location, preferences, etc. The interaction may be stored whether it is a first-time or a known user, with the first time user's profile being created in S252 before the interaction is stored in said profile. The profile may be stored on a database within the kiosk, on a local network in communication with the kiosk, on an online database such as the internet, or any combination thereof. Moreover, the method as shown may not be limited to the order provided, particularly with respect to steps S255-S258. In other words, the interaction may continuously be stored S258 and used to customize the information presented in S256 before it is determined that the interaction is terminated S257. Other combinations are possible, and may be apparent to one having ordinary skill in the art in light of this disclosure.

FIGS. 3A and 3B show a mobile device for remotely controlling a kiosk, according to an example embodiment of the subject disclosure. With reference to FIG. 3A, mobile device 301 includes a display 305, a keypad 307, a microphone 308, and an antenna 303. With reference to FIG. 3B, mobile device 301 further includes a central processing unit (CPU) 309, a memory 311 for storing logic 312 among other things, a transceiver 313, a second transceiver 314, a global positioning system (GPS) receiver 316, a camera 317, and a battery 318. Display 305 may be an LCD, LED or any other type of display on which a user can view selections, numbers, letters, etc. Display 305 may also be a touchscreen, thereby being used as an input device as well. In embodiments not using a touchscreen, a keypad 307 may typically be used as an input device, for instance, to type a telephone number or a message. Such a keypad may be a numerical keypad, a QWERTY keyboard, etc. Microphone 308 may allow the user to verbally communicate with others and to input voice commands. Antenna 303 may be a transducer designed to transmit or receive electromagnetic waves to and from another entity via a wireless connection network.

In conjunction with antenna 303, transceiver 313 allows mobile device 301 to communicate with a cellular network, or with other devices across any other type of network, such as a personal area network, Wi-Fi, NFC, etc. Transceiver 313 may be a cellular transceiver, wireless transceiver, etc., and may include combinations of transceivers to communicate with assorted wireless networks. Similarly, NFC transceiver 314 is shown as an additional transceiver, enabling communication with other devices including a kiosk. However, other transceivers may be included within mobile device 301. CPU 309 controls components of mobile device 301 according to instructions programmed within or stored on memory 311. Memory 311 comprises any computer readable medium, such as RAM, ROM, etc. For instance, logic stored on memory 311 may include an operating system running on today's mobile devices, such as IOS, ANDROID, WINDOWS MOBILE, SYMBIAN, etc. Further, logic 312 may include instructions for detecting (via one of transceivers 313, 314) a kiosk, and enabling a user to interact with the kiosk via an interface displayed on display 305. The instructions within logic 312 may further include the method steps described with respect to FIG. 4.

Camera 317 may include a photo-sensitive sensor and additional hardware required to record and store images and videos. Camera 317, in conjunction with logic 312, may additionally be used as a biometric identifier of the user. For instance, camera 317 may be used to capture an image of the user and transmit the image to a kiosk, enabling the kiosk to authenticate the user before retrieving the user's profile. Camera 317 may also be used to scan a bar-code or other visual identifiers of the kiosk before enabling the user to interact with the kiosk, thereby providing an additional layer of security for the user in the event of a fraudulent entity claiming to be an information kiosk. Moreover, although mobile device 301 is shown to include a camera as a biometric sensors, other biometric sensors may be included to replace or complement camera 317 such as a fingerprint sensor, or logic for voice recognition via microphone 308, etc. Further, biometric devices may not necessarily be coupled to the mobile device, and may be attached to a user via other methods such as clothing, etc., while remaining in wired or wireless communication with the mobile device. A password may be used to accompany any requests and/or biometric identifiers as an additional layer of security and to verify that an authorized user is using the mobile device and requesting information.

A GPS receiver 316 enables location determination to facilitate location-based services and customization of information for mobile device 301. A battery 318 may provide power to each of the components of mobile device 301, and may include an interface to an external power supply. Battery 318 may be any of the presently known or later developed technologies used in mobile devices or used in powering communication components including Lithium-Ion batteries, lithium-polymer batteries, molten salt batteries, etc. Mobile device 301 may further include cellular telephones, laptops, tablets, etc., and therefore may include additional hardware that is not shown, such as subscriber identity module (SIM) or universal integrated circuit cards (UICC), etc. These modules may further be used to store and/or enable the functions offered by logic 312. Further, multiple input methods besides the ones shown may be used to control a kiosk. For instance, a camera or other sensor of a mobile device may be used to monitor a user's eye or hand movements, and correspondingly issue commands to a kiosk. Gestures may be detected by optical, gyroscopic, or other sensors as a means to control a kiosk while avoiding actual physical contact with the kiosk.

FIG. 4 shows a method for remotely controlling a kiosk, according to an example embodiment of the subject disclosure. This method may be executed by logic 312 as shown with respect to FIG. 3, or may be executed by any other type of mobile device conceivable to one having ordinary skill in the art in light of this disclosure. According to this method, a user's mobile device may detect S460 a presence of a kiosk, and initiate a connection with the kiosk. For instance, a user may approach to within a communication range of the kiosk sufficient to enable such detection as described above. Moreover, the kiosk may detect the mobile device and “push” a notification to the mobile device. This detection may occur via any combination of transceivers within the mobile device or the kiosk, and may trigger an alert to the user via the mobile device. The alert may further be provided by the kiosk, such as a display or an audio signal indicating to the user to enable communication by commanding their mobile device. For instance, logic within the mobile device may alert the user of the presence of the kiosk, and may provide the user with an option to connect with the kiosk to request information.

Once the kiosk is detected S460, logic on the mobile device may determine S461 whether this is a known kiosk or a new interaction with a previously unknown kiosk. Determination S461 may include comparing a unique identifier of the kiosk, including but not limited to IP addresses, MAC addresses, public/private keys, etc., with a database or table of known identifiers corresponding to known kiosks. The database of known identifiers may be programmed by the user on a per-use basis, i.e. each previous interaction may be recorded. Alternatively or in combination, the database may be provisioned by a network operator, service provider, kiosk operator, or any other entity, either beforehand, or after step S460 of detecting the kiosk. Other combinations may be possible. In either case, if the kiosk is a recognized kiosk, then the interaction may continue with receiving or displaying a menu of options S464 for the kiosk. The menu of options may be customized for the user (if the kiosk also recognizes the user and loads the user's profile), or may be a default menu of options. The menu of options may further be displayed on the mobile device, on the kiosk, or combinations thereof. For instance, and as shown below, the menu of options may include an abbreviated menu on the mobile device, such as a menu of controls, and more detailed information on the main display of the kiosk.

If the kiosk is not recognized, it may be assumed that this may be the first time the user is using this type of kiosk or set of kiosks, and the mobile device may request that a profile be set up for the user S462. This step may be initiated by the mobile device, perhaps via a command by the user, or may be automatic depending on the configuration of the particular kiosk. Further, the identifier and other information (such as location, etc.) of the kiosk itself may be stored S463 either locally on the mobile device or on a network storage associated with an account of the user. Storing the kiosk on the network storage may ensure a level of redundancy, especially if the kiosk itself can access this information, thereby bolstering the relationship between the user and the operator of the kiosk. Subsequent to requesting a profile S462 and storing the kiosk S463, the menu of options may be displayed S464 as described above. The menu options may further be presented S464 in response to a query submitted in an initial request from the mobile device. For instance, a query from a new user requesting information on men's shoes from a kiosk in a mall may result in a list of men's shoe stores within the mall and directions to said stores, while an identical query from a user already having a profile could limit the list of options to shoe stores having items matching the user's shoe size, budget, purchase history, age, and any other information available to the kiosk. Further, the choice of where to display the menu of options may be customized to the user's preferences.

The interaction may continue with mobile device transmitting an input in the form of a query or menu selection S465 from the user via a combination of an interface and input device on the mobile device. This may be a continuation of the previous interaction, such as narrowing down a bus route to a specific time, or a particular product to a range of prices. Alternatively, this may include a new query, such as selecting a train instead of a bus, or adding an item to be purchased to the query. In either case, a response may be presented S466 to the user (either on the kiosk or on the mobile device) and the interaction process may repeat itself or may end, depending on the outcome of decision S467. For instance, if the user continues to provide input, narrowing or broadening his query, steps S465-S467 may be repeated. If there is no more input from the user, or if the user somehow terminates the session, for instance via a command on his mobile device, the entire interaction may be stored in the user's profile, with said customization being confirmed by the user S468, so as to enable more customization for future uses of this or another connected kiosk. The information stored may include every query and selection from a menu of options, as well as other information such as the user's history of interactions, geographical location, preferences, etc. The interaction may be stored whether it is a first-time or a known user, with the first time user's profile being created in response to request S462 before the interaction is stored in said profile. The profile may be stored on a database within the kiosk, on a local network in communication with the kiosk, on an online database such as the internet, or any combination thereof. Further, the mobile device may store the interaction independently, either on a local storage or on a network, and may also store information related to the kiosk as in step S463, so as to potentially recognize new kiosks owned or operated by the same entity. Moreover, the method as shown may not be limited to the order provided. For instance, the interaction may be continuously stored S463 and S468 and used to customize the information presented in S466 before it is determined that the interaction is terminated. Other combinations may be possible, and may be apparent to one having ordinary skill in the art in light of this disclosure.

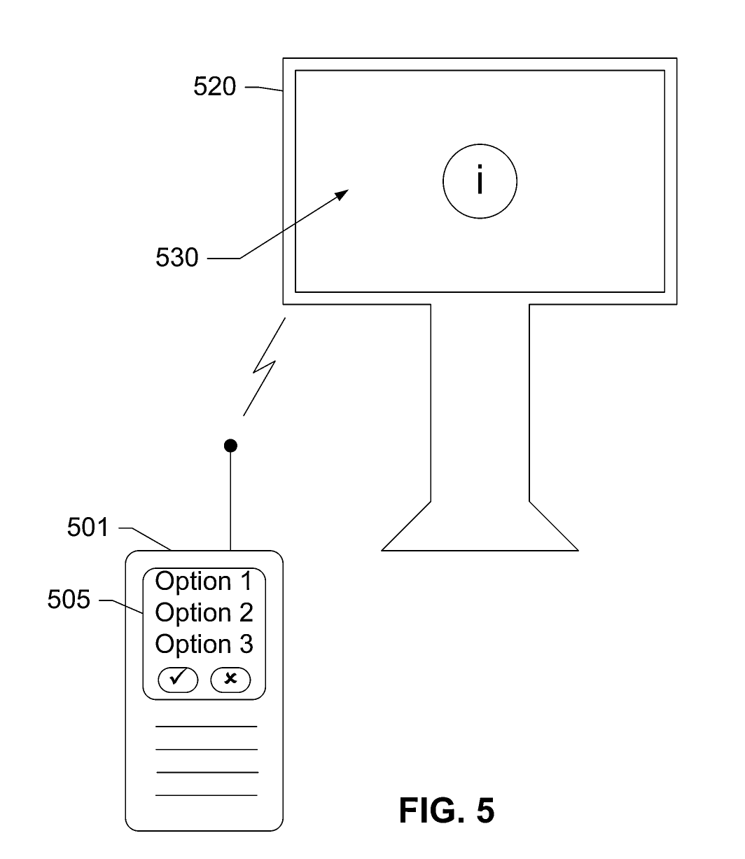

FIG. 5 shows a kiosk being remotely controlled by a mobile device, according to an example embodiment of the subject disclosure. As described above, a user may interact with a kiosk 520 having a display 530, using his mobile device 501 as a remote control, for instance via an interface provided by logic stored on the mobile device, enabling the user to control the kiosk without coming into physical contact with the kiosk. In this example embodiment, the user may be receiving information on display 530 of kiosk 520, while further receiving a menu of options on display 505 of mobile device 501. The user interface depicted on display 505 may be launched via an application stored on a memory of mobile device 501, via an HTTP or similar interface such as a browser, etc. The user may select options from the menu of options, with the user's input being transmitted wirelessly to kiosk 520. The information displayed on kiosk 520 may reflect the user's input pursuant to the methods described herein.

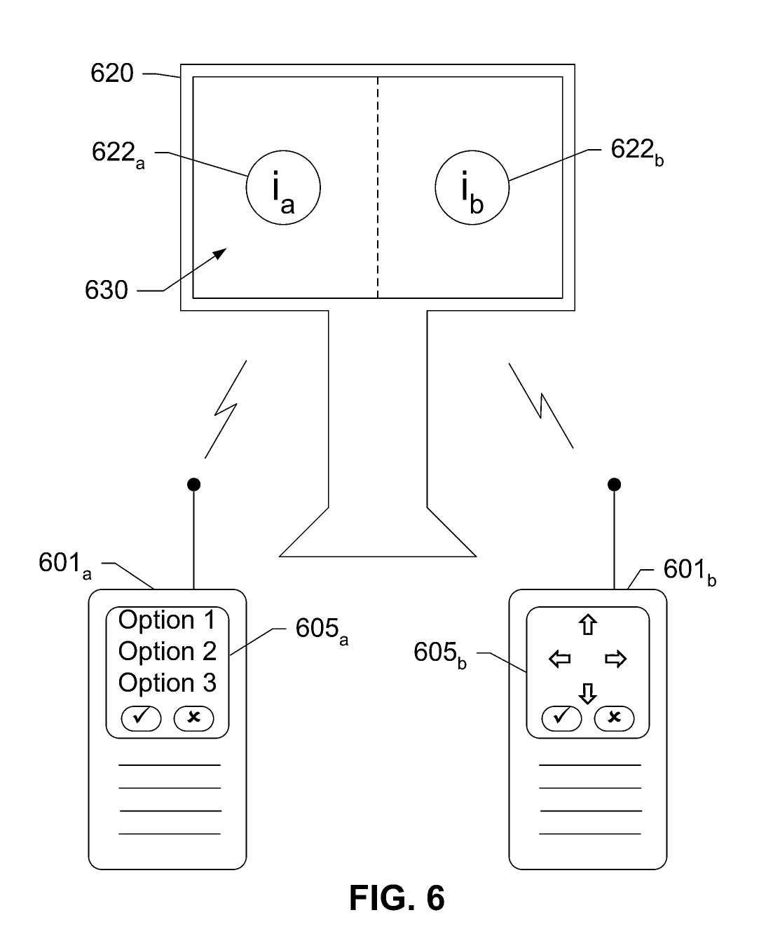

While FIG. 5 shows an interaction between a single mobile device and a kiosk, multiple users may concurrently interact with a kiosk. FIG. 6 shows a kiosk being remotely controlled by two mobile devices, according to an example embodiment of the subject disclosure. For instance, two users of mobile devices 601ₐ and 601_{b} may be in a wireless interaction with kiosk 620 having a display 630. As shown, both users are viewing information depicted on display 630 of kiosk 620, with display 630 being split in half. Information 622ₐ is being shown on one half of display 630 in response to input received from mobile device 601ₐ via interface 605ₐ, while information 622_{b} is being shown on the other half of display 630 in response to input received from mobile device 601_{b} via interface 605_{b}. Logic on kiosk 620 may be able to determine a position of each mobile device 601_{a-b} via one or more sensors, and correspondingly split the display between information 622_{a-b} respectively. Further, as shown, different user interfaces may be shown on each mobile device. For instance, mobile device 601ₐ shows a text-based user interface 605ₐ, with buttons for confirming or canceling selections. Mobile device 601_{b} may show a directional control pad on interface 605_{b}, perhaps used to navigate and activate menu selections shown on information 622_{b}. Other combinations of interfaces may be possible and may become apparent to those having ordinary skill in the art in light of this disclosure.

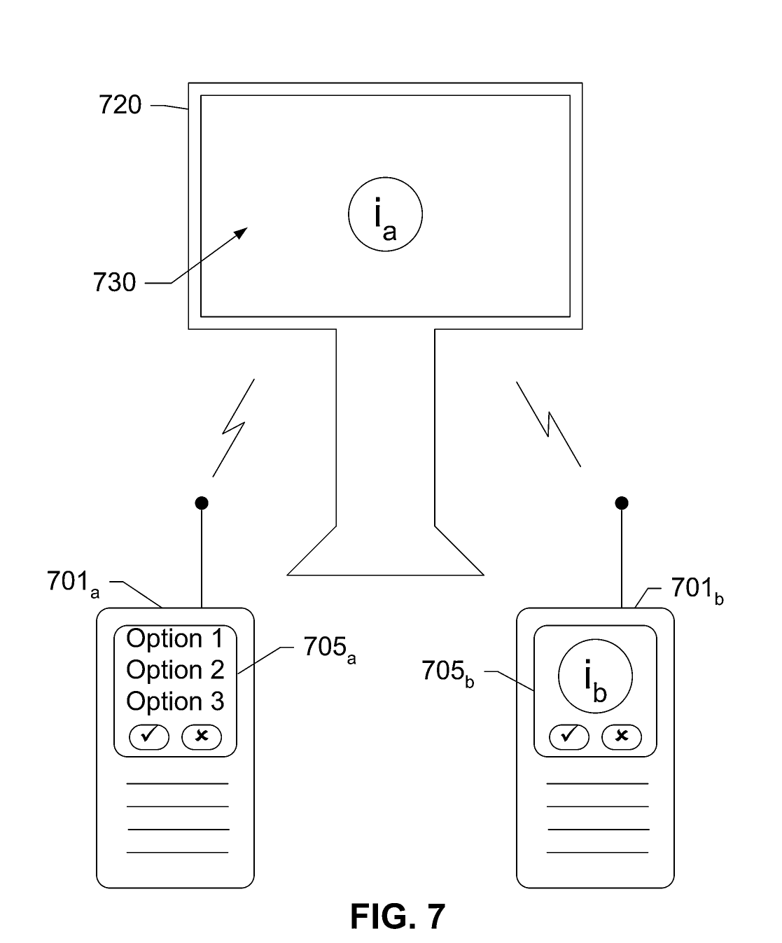

FIG. 7 shows a kiosk being remotely controlled by two mobile devices with one mobile device in a private session, according to an example embodiment of the subject disclosure. This is one of many potential distributions or allocations of information between a display of a kiosk and a display of a mobile device. In the example embodiment of FIG. 7, two users of mobile devices 701ₐ and 701_{b} may be in a wireless interaction with kiosk 720. As shown, user of mobile device 701ₐ is viewing information depicted on display 730 of kiosk 720, which may cover display 730 entirely. This information is being shown in response to input received from mobile device 701ₐ via interface 705ₐ. In contrast, information relevant to input received from mobile device 701_{b} via interface 705_{b}. may be shown only on the display of mobile device 701_{b}. Logic on kiosk 720 may have received a request from user of mobile device 701_{b} or may have retrieved a preference from a profile of the user to initiate a private interaction, consequently limiting the public from being able to view information relevant to user of mobile device 701_{b}. Other combinations of interfaces are possible and may become apparent to those having ordinary skill in the art in light of this disclosure. For example, upon detecting more than one mobile device, logic on kiosk 720 may simply turn off display 730 to protect the privacy of multiple users and instead, information relevant to input received from each mobile device may be displayed on the display of that mobile device only. Further, in any embodiment including multiple users, logic on the kiosk may be able to detect a plurality of requests from the users, and may allocate time limits for interactions, as well as be able to prioritize interactions based on information in the user's profile, such as scheduling information, subscription levels, etc.

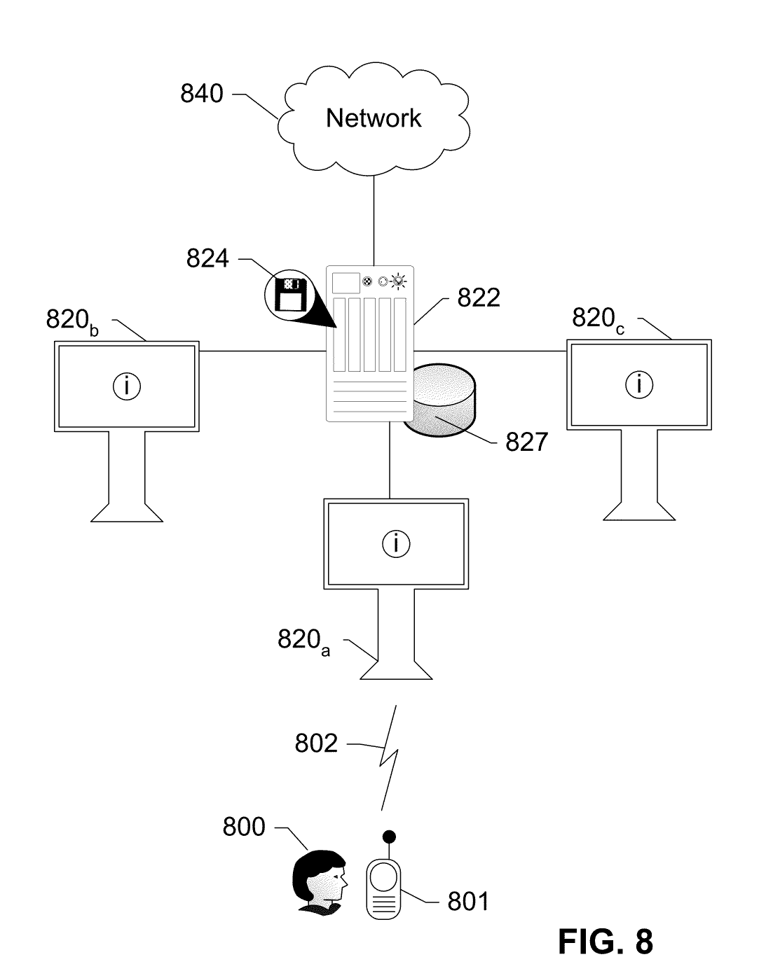

FIG. 8 shows a system including a plurality of locally-distributed kiosks, according to an example embodiment of the subject disclosure. For instance, multiple kiosks 820ₐ, 820_{b}, and 820_{c}, distributed throughout a shopping mall or other local area, may be coupled to a server 822 on the premises via a local area network connecting the kiosks, such that information may be provided to the user 800 based on the user's location within the local area. The system may include a user 800 operating a mobile device 801. Mobile device 801 may be in wireless communication with a kiosk 820ₐ over a wireless connection 802. Wireless connection 802 may be implemented via any mechanism including near-field communication (NFC), WiFi, cellular, broadband, etc. Further, kiosk 820ₐ may also include one or more transceivers for enabling such communication, as well as communication with server 822. Server 822 may host logic 824 for performing the information dissemination as well as storing user's profiles on database 827, while managing kiosks 820ₐ, 820_{b}, and 820_{c} on the network. Server 822 may further be in communication with network 840. Network 840 may include wide-area networks such as the Internet, etc. For instance, network 840 may enable access to a service provider's core network, including account information for user 800 and an owner/operator of kiosks 820_{a-c}, a billing server, as well as a central storage database for user 800.

The user's interactions with either kiosk, as well as any user-provided information, demographics, etc. may be stored in the user's profile either on database 827 or on a network database accessible via network 840, or any combination thereof. For instance, kiosk 820ₐ may be installed in a public transit terminal, such as a bus station or an airport, with the user's travel patterns and flight schedules being stored on a database and accessible via server 822. In another situation, kiosk 820ₐ may be installed in a shopping mall and serve as a mall directory, with the user's purchasing preferences, budget, etc. being stored on database 827 or otherwise accessible by server 822 that would push their recommendations along with information targeted to the user to kiosk 820ₐ, or any other kiosk that the user may be interacting with.

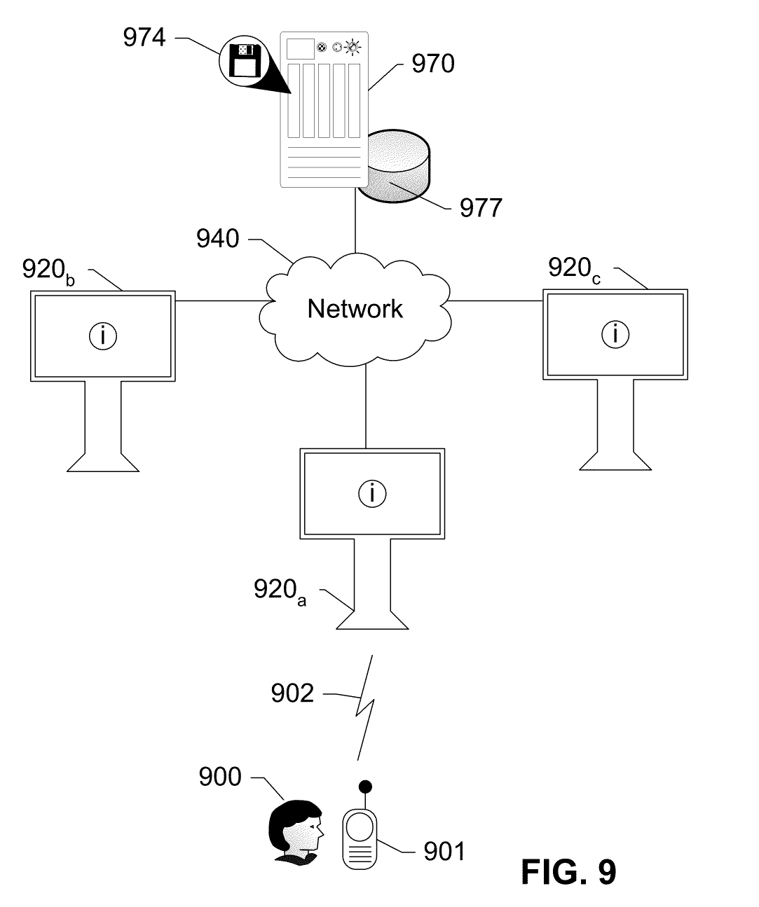

FIG. 9 shows a system including a plurality of widely-distributed kiosks, according to an example embodiment of the subject disclosure. This example embodiment may be implemented in a situation where widely-distributed kiosks may provide the same type of information for a variety of users in a variety of locations. For instance, multiple kiosks 920ₐ, 920_{b}, and 920_{c} may be situated at bus stops distributed throughout a city, municipality, etc., and may be in communication with a remote server 970 via a wide area network such as the Internet. A user 900 operating a mobile device 901 may interact with one kiosk 920ₐ over a wireless connection 902. Wireless connection 902 may be implemented via any mechanism including near-field communication (NFC), WiFi, cellular, broadband, etc. and as described herein. Either of kiosks 920_{a-c} may include appropriate hardware and software for communicating with a mobile device and for disseminating information to the mobile device. Further, kiosks 920_{a-c} may communicate with server 970 for any number of purposes, including retrieving and/or writing to a user's profile hosted on database 977, as well as receiving instructions for disseminating information from logic 974. Network 940 may include wide-area networks such as the Internet, etc., and may further enable access to a service provider's core network. For instance, server 970, database 977, and logic 974 may be hosted on the service provider's core network, with kiosks 920_{a-c} disseminating information to user 900 regularly as shown above, and only contacting server 970 upon completion or initiation of the interaction with user 900. Moreover, logic such as logic 974 may be programmed on a combination of servers and/or a complex of servers. A particular logic unit may not be limited to a single logical location on the network.

As described above, biometric identifiers may be used along with or as an alternative to unique identifiers and passwords to accompany any requests for information from the mobile device, thereby providing an additional layer of security. Moreover, additional privacy control measures may be provided to a user to control the information in their personal profile. The user may be able to access, via any other networked device, their profile, and retrieve, erase, or otherwise modify any personal history, search queries, and results. Further, the user may create “avatars” or personas under which particular queries may be submitted to different kiosks. In other words, an operator of a kiosk may never know the true identity of a person, but simply a persona that the user may wish to portray. Consequently, many types of identity theft may be prevented, since the unique ID associated with the user may be known only to the user and associated with the user's most secure information, while other information may be assigned to an avatar or persona without publicly being associated with the user's unique ID.

Further, recommendations may additionally be provided in the form of advertisements that may not necessarily be related to the information requested or query submitted by the user. Advertisers may place their advertisements within a user interface of the kiosks, and may have limited access to the user's information such as demographics, search history, purchase history, etc., with the user having the ability to adjust the level of access. For instance, a user may enable advertisers contracting with a shopping mall directory to connect with user's virtual closet, and provide clothing and/or fashion recommendations based on an inventory in the user's virtual closet. The concept of the virtual closet is described in commonly owned and co-pending application Ser. No. ______, the contents of which are incorporated by reference herein in their entirety into this disclosure.

The foregoing disclosure of the example embodiments of the subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the subject disclosure, the specification may have presented the method and/or process of the subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the subject disclosure should not be limited to the performance of their steps in the order written, and one skilled in the art can readily appreciate that the sequences may be varied and still remain within the spirit and scope of the subject disclosure.

What is claimed is:

1. A system, comprising:
a kiosk including a processor, a display, and a transceiver; and
a computer-readable medium in communication with the processor, the computer readable medium storing a logic that, when executed by the processor, causes the processor to perform operations including:
receiving a connection request from a mobile device associated with a user,
presenting a plurality of options,
receiving a query from the mobile device, the query identifying at least one of the plurality of options,
presenting a response based on the query, and
storing the query, the response, and any subsequent query in a profile for the user, the profile being stored in a database in communication with the kiosk,
wherein the query is submitted responsive to a user input detected via a user interface on the mobile device.

2. The system of claim 1, wherein the logic further includes computer-readable instructions for checking the database for an existing profile for the user in response to receiving the query.

3. The system of claim 1, wherein the query includes a unique identifier associated with the user.

4. The system of claim 1, wherein the query includes a biometric identifier of the user.

5. The system of claim 1, wherein the database is stored on a server in communication with the kiosk.

6. The system of claim 5, wherein the server is accessible to the kiosk via a wide-area network.

7. The system of claim 1, wherein the database is accessible to the mobile device via a wide-area network.

8. The system of claim 1, wherein the mobile device accesses the database via a cellular network.

9. The system of claim 1, wherein the logic further includes computer-readable instructions for alerting the mobile device that the kiosk is within a range of the mobile device, the range being determined by the transceiver detecting a presence of the mobile device.

10. A method, comprising:
receiving, at a kiosk including at least a processor, a query from a mobile device in communication with the kiosk, the query including an identifier of a user of the mobile device;
presenting, by the kiosk, a response to the query; and
storing, on a database in communication with the kiosk, the query, the response, and any subsequent query in a profile associated with the user,
wherein the query is submitted responsive to a user input detected at an interface on the mobile device.

11. The method of claim 10, wherein in response to the query, the method further comprises checking the database for an existing profile associated with the user.

12. The method of claim 11, further comprising customizing the response based upon the existing profile for the user.

13. The method of claim 10, wherein the profile includes at least one of a past query of the user, a location of the user, a plurality of demographics of the user, or a user preference.

14. The method of claim 13, wherein the user preference includes a preference to engage in a private interaction with the kiosk.

15. The method of claim 13, wherein the user preference includes a preference to automatically connect to the kiosk.

16. The method of claim 10, further comprising presenting the response on a first display coupled to the kiosk.

17. The method of claim 10, further comprising presenting the response on a second display coupled to the mobile device.

18. The method of claim 10, further comprising presenting a set of controls to the mobile device.

19. The method of claim 18, wherein the controls are presented on a user interface of the mobile device.

20. A computer program product embodied on a non-transitory computer-readable storage medium in communication with a processor, the computer program product including computer-readable instructions that are executed by the processor to perform operations comprising:
receiving a connection request from a mobile device in communication with a kiosk, the connection request including a query and an identifier of a user of the mobile device;
presenting a response to the query via a display; and
storing the query and the response in a profile associated with the user, the profile being stored on a database in communication with the kiosk,
wherein the user submits the query via an interface on the mobile device.
